(19) United States
(12) Patent Application Publication
(10) Pub. No.: US 2007/0125562 A1
(43) Pub. Date: Jun. 7, 2007

(54) Method of controlling striking force and rebounding force for electric nailing machine

(75) Inventor: Han-Ching Chen, Taichung City (TW)

Correspondence Address: BACON & THOMAS, PLLC, 625 SLATERS LANE, FOURTH FLOOR, ALEXANDRIA, VA, 22314, US

(73) Assignee: MOBILETRON ELECTRONICS CO.,LTD., TAICHUNG HSIEN (TW)

(21) Appl. No.: 11/500,281

(22) Filed: Aug. 8, 2006

(30) Foreign Application Priority Data
Dec. 4, 2005 (TW) 94143232

(51) Int. Cl. B25B 21/02

(52) U.S. Cl. 173/1

(57) ABSTRACT

A method of controlling striking force and rebounding force for an electric nailing machine employs a control device to control the trigger time spot of the AC power source through a coil and a piston mounted, both of which are mounted inside the electric nailing machine to further control the striking force through excitation working on different positions of the coil by the piston. A spring provides the piston with required rebounding force for return of the piston after striking the nail. Thus, the control device controls the trigger time spot of the AC power source and the rebounding force of the piston.

### BACKGROUND OF THE INVENTION

1. Field of the Invention

The present invention relates generally to electric nailing machines, and more particularly, to a method of controlling striking force and rebounding force for an electric nailing machine.

2. Description of the Related Art

A conventional electric nailing machine, while operated, employs an alternate current (AC) power source to excite a coil and then the coil attracts a piston which is held in a ready position by the resilience of a spring in the normal time. While the piston is attracted, the attraction overcomes the resilience of the spring to enable the piston to move to a striking position and to strike a nail, thus accomplishing a striking action of the nail. After the striking action is done, the piston under the resilience of the spring returns to the original (ready) position. However, the resilience of the spring is not weak, and while returning to the ready position, the piston actually crashes back to the position; meanwhile, the user definitely feels shocked on the hands to think of failing to do the operation in one hand. In addition, several strikes may deteriorate or destroy the internal structure of the nailing machine.

So far, the development of most of the art focuses on how to enhance the striking force to definitely strike the nail into a workpiece and almost none of them focuses on the control of the rebounding force of the piston. I have thought that reduction of the resilience of the spring may though improve the problem but the returning speed of the piston becomes slow and the next striking action will take more time. In addition, if the stroke of the piston is shortened, the rebounding stroke of the spring will be shortened either but to reduce the striking force. Thus, neither the former solution nor the latter one is feasible.

### SUMMARY OF THE INVENTION

The primary objective of the present invention is to provide a method of controlling striking force and rebounding force for an electric nailing machine, which can control the striking force working on a nail and the rebounding force working on the piston while the piston returns.

The secondary objective of the present invention is to provide a method of controlling striking force and rebounding force for an electric nailing machine, which controls the trigger time spot with respect to the AC power source to control the time spot of exciting a coil, further controlling the rebounding force of the piston.

The foregoing objectives of the present invention are attained by the method, by which a control device is taken to control the trigger time spot of the AC power source through a coil and a piston mounted, both of which are mounted inside the electric nailing machine to further control the striking force through excitation working on different positions of the coil by the piston; a spring provides the piston with required rebounding force for return of the piston after striking the nail; and then the control device controls the trigger time spot of the AC power source and the rebounding force of the piston.

In one embodiment of the present invention, the method includes steps of controlling the trigger time spot of the coil with respect to the AC power source to determine the excitation working on the coil and to further control attraction generated by the excitation to the piston to control the striking force of the piston, while a striking action is proceeding and the piston is located at an end of the coil; controlling the trigger time spot of the coil with respect to the AC power source again to determine the excitation working on the coil to enable the attraction to slightly holds the piston to further control the rebounding force of the piston after the striking action is done and the piston is located at a striking position to be ready for return under the resilience of the spring.

### BRIEF DESCRIPTION OF THE DRAWINGS

FIGS. 1(A) and 1(B) are schematic views of a first preferred embodiment of the present invention.

FIG. 2 is a block diagram of circuitry of the first preferred embodiment of the present invention.

FIGS. 3(A)-3(C) are schematic views of a second preferred embodiment of the present invention in operation.

### DETAILED DESCRIPTION OF PREFERRED EMBODIMENTS

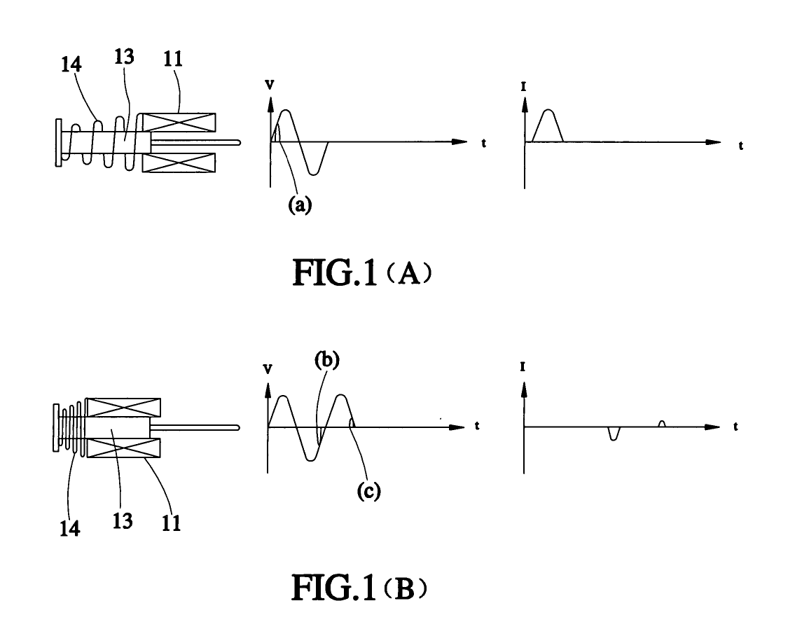

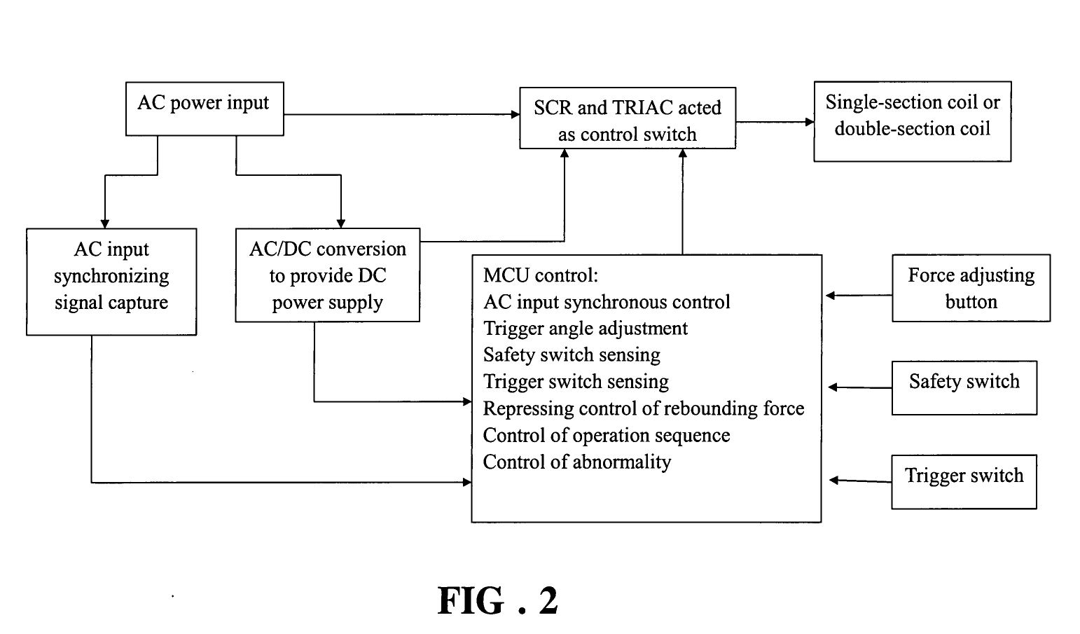

Referring to FIGS. 1(A) and 1(B), a method of controlling striking force and rebounding force for an electric nailing machine is based on a first preferred embodiment of the present invention. The electric nailing machine includes a coil 11 and a piston 13. In cooperation with a control device 21, the coil 11 and the piston 13 control trigger time spot of AC power source, as shown in FIG. 2. The control device 21 controls a triode AC semiconductor switch (TRIAC) 23 through a microprocessor 22 to do trigger and conduction of the AC power source. The piston 13 is taken with respect to different positions of the coil 11 to be excited to control the stroke thereof to further control the striking force thereof. The piston 13 is provided with required rebounding force generated by a spring 14 for return after the striking action is done. The rebounding force is controlled by the control device controlling the trigger time spot of the AC powers source. The method includes the following steps:

the following steps:

A. Control the trigger time spot (a) of the AC power source with respect to the coil 11 for trigger, while the striking action is proceeding as shown in FIG. 1(A), to determine how much electric energy of the excitation the coil 11 takes. In this embodiment, the trigger time spot (a) while the striking action is proceeding is located at a front section of a half wave of an AC of since wave to control attraction generated by the excitation of the coil 11 to the piston 13 to further control the striking force of the piston 13.
B. Control the trigger time spots (a) of the coil 11 with respect to the AC power source for trigger, after the striking action is done and the piston 13 is located at a striking position to start returning under the resilience of the spring 14, as shown in FIG. 1(B), to determine how much electric energy of the excitation the coil 11 takes. In this embodiment, the trigger time spots (a) after the striking action is done is located at a rear section of a half wave of an AC of since wave and have two trigger time spots (b) and (c), which are located at two half waves of the AC sine wave respectively for trigger to enable the coil 11 to generate two excitation reactions and to slightly hold the piston 13 by two-stage attraction through the coil 11 while the piston 13 returns. In the meantime, the resilience of the spring 14 is partially neutralized and the rebounding force of the piston 13 is reduced.

In light of the above, the striking force and the rebounding force can be controlled. In addition, it is to be noted that some blocks are not marked with reference numbers because they belong to the prior art but they are shown for assistant illustration.

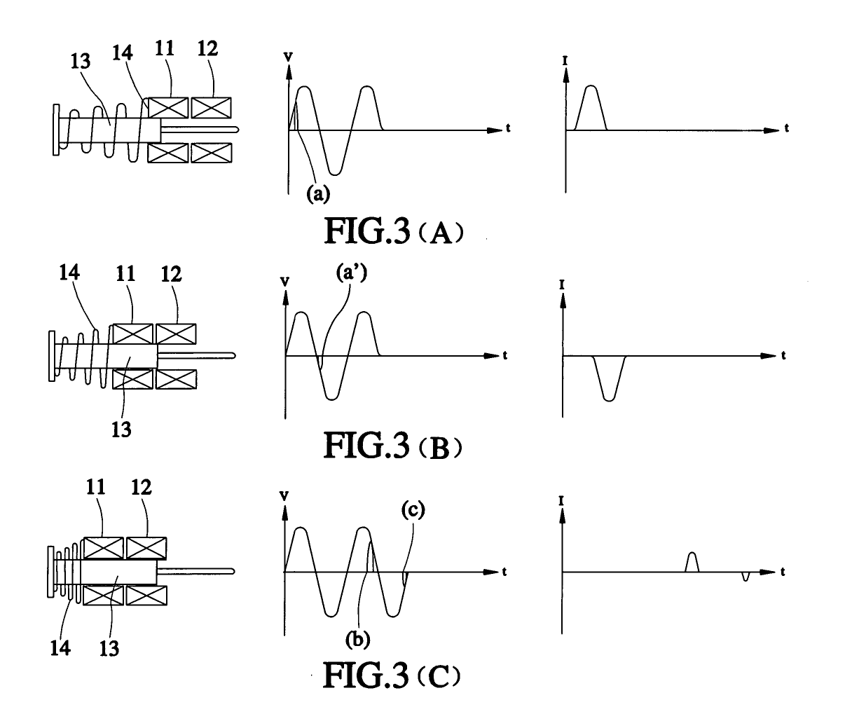

Referring to FIGS. 3(A)-3(B) again, a method of controlling striking force and rebounding force for an electric nailing machine, based on a second preferred embodiment of the present invention, is similar to the first embodiment, having difference recited below.

There are two coils including a first coil 11 and a second coil 12, which are serially arranged. Controlling the trigger time spots of the coils 11 and 12 with respect to the AC power source can determine how much the striking force and the rebounding force of the piston are. While the rebounding force is being controlled, the second coil 12, which is located the closest to the striking position between the two coils, is employed to control the rebounding force.

FIG. 3(A) illustrates the correlative position of the piston 13 and the two coils, the trigger time spot (a) of the first coil 11 with respect to the AC power source, and the electric energy generated. FIG. 3(B) illustrates the position of the piston 13 during the striking action and the trigger time spot (a′) of the second coil 12 with respect to the AC power source. FIG. 3(C) illustrates the trigger time spots (b) and (c) of the second coil 12 after the piston 13 reaches the striking position. In the meantime, the piston 13 is likewise held slightly by the attraction such that the resilience of the spring 14 is partially neutralized to reduce the rebounding force of the piston 13.

In conclusion, the present invention includes the following advantages.
1. Controllable Striking and Rebounding Forces
In addition to the striking force of the piston on the nail, the present invention can control the rebounding force of the piston, after the striking action is done, to decrease the impact generated while the piston returns under the resilience of the spring, further preventing the nailing machine from structural damage.
2. Easy Operation
The present invention decreases the impact of the piston such that the user feels less shocked while operating the nailing machine to facilitate single-hand operation of the nailing machine for the user.

Although the present invention has been described with respect to two specific preferred embodiments thereof, it is no way limited to the details of the illustrated structures but changes and modifications may be made within the scope of the appended claims.

What is claimed is:

1. A method of controlling striking force and rebounding force for an electric nailing machine, said electric nailing machine cooperating with a control device and having a coil, a piston, and a spring, all of which are mounted therein, said method comprising steps of:
controlling a trigger time spot of said coil with respect to an alternate current (AC) power source, while a striking action is proceeding and said piston is located at an end of said coil, to determine how much electric energy should be provided to said coil for excitation to control attraction generated by the excitation to said piston to further control striking force of said piston; and
controlling at least one trigger time spot of said coil with respect to the AC power source, after the striking action is done and while said piston is located a striking position and ready to return under the resilience of said spring, to determine how much electric energy should be provided to said coil for excitation to enable said piston to be slightly held by the attraction of said coil, while said piston returns, to further control rebounding force of said piston.

2. The method as defined in claim 1, wherein said trigger time spot with respect to the AC power source for control of the striking force is located at a front section of a half wave of an AC sine wave; said trigger time spot with respect to the AC power source for control of the rebounding force is located at a rear section of a half wave of an AC sine wave.

3. The method as defined in claim 2, wherein there are at least two trigger time spots after the striking action is done, said at least two trigger time spots being located at at least two half waves of the AC sine wave respectively for trigger to enable the coil 11 to generate at least two excitation reactions for multi-stage attraction of the excitation to said piston which is returning.

4. The method as defined in claim 2, wherein said control device controls a triode AC semiconductor switch (TRIAC) through a microprocessor for trigger and conduction of the AC power source.

5. The method as defined in claim 1, wherein said nailing machine comprises at least two coils serially arranged, whereby the trigger time spots of said two coils with respect to the AC power source are controlled respectively to determine how much the striking and rebounding forces are.

6. The method as defined in claim 5, wherein the rebounding force is controlled through the last one of said at least two coils.
